(19) United States
(12) Patent Application Publication
(10) Pub. No.: US 2007/0137934 A1
(43) Pub. Date: Jun. 21, 2007

(54) Portable tool lubrication system

(75) Inventors: David N. Nappier, Caseyville, IL (US); Dustin D. Ribble, Hettick, IL (US)

Correspondence Address: TUNG & ASSOCIATES, Suite 120, 838 W. Long Lake Road, Bloomfield Hills, MI, 48302, US

(73) Assignee: The Boeing Company

(21) Appl. No.: 11/268,861

(22) Filed: Nov. 7, 2005

(51) Int. Cl. B23Q 11/12

(52) U.S. Cl. 184/6.14

(57) ABSTRACT

A cutting tool lubrication system, suitable for use with portable, hand-held machine tools, automatically delivers single, pre-measured shots of oil to the cutting tool each time the operator powers up the machine tool. The lubrication system is carried on or with the tool and is operated by the same power source that drives the machine tool, such as compressed air. The lubrication system includes a lubricating fluid reservoir, a fluid pump, and a series of check valves for controlling the flow of fluid between the reservoir, the pump and a nozzle from which the fluid is dispensed.

### FIELD OF THE INVENTION

This invention generally relates to systems for lubricating cutting tools, and deals more particularly with a lubrication system that can be carried on a portable power tool, such as a drill.

### BACKGROUND OF THE INVENTION

Machine tools use a variety of cutting tools such as milling heads and drills to cut and shape parts and workpieces, particularly those formed of metal. Lubricating fluids, also referred to as cutting oils, are often used to lubricate the metal-to-metal contact between the cutting tool and the workpiece, in order to reduce friction and increase cutting rate. Lubricating fluids also reduce the temperature of both the workpiece and the cutting tool during the cutting process. Accordingly, lubricating fluids increase tool life and improve the quality of the machined parts.

A variety of sophisticated tool lubrication systems have been devised in the past, especially for larger machine tools, such as mills, lathes and drills. Some machining operations, however, require the use of portable, hand held power operated machine tools. For example, in the aircraft industry, small hand-operated drills are used to form fastener holes for rivets or screw, which are used to fasten an outer skin to structural members. In the past, the drill operator would manually apply a small quantity of cutting oil or other lubricating fluid to either a drill bit or an area of the workpiece in which a hole was to be drilled. This manual application of lubricating fluid sometimes resulted in too much or too little oil being applied. In any event, the procedure was time consuming since it required the operator to perform an additional step for each hole that was drilled. Moreover, the procedure was subject to oil spillage, prompting the need for cleanup and maintenance.

Accordingly, there is a need in the art for a portable tool lubrication system which overcomes the deficiencies of the prior art discussed above. The present invention is directed towards satisfying this need.

### SUMMARY OF THE INVENTION

According to one aspect of the invention, a lubrication system for a portable machine tool is provided, comprising a reservoir for holding lubricating fluid, a nozzle for dispensing a pre-selected quantity of lubricating fluid, a pump assembly for drawing the fluid from the reservoir and pumping a pre-selected quantity of the fluid to the nozzle, and a pump control responsive to operation of the machine tool for causing the pump to pump the pre-selected quantity of fluid to the nozzle. The pump preferably comprises a cylinder assembly having a cylinder into which a pre-selected quantity of lubricating fluid is drawn from the reservoir. The piston has a forward stroke in which the pre-selected quantity of lubricating fluid is pumped to the machining operation, and a return stroke in which the next quantity of fluid is drawn from the reservoir. Check valves are provided that prevent backflow of fluid from the pump to the reservoir, and from the machining operation back to the pump. The stroke of the piston is adjustable, thereby allowing precise metering of the size of the fluid shot delivered to the cutting operations. Both the drill and the pump are driven by a source of compressed air.

According to another aspect of the invention, a cutting tool lubrication system carried on a portable machine tool, comprises a reservoir for holding lubricating fluid, a dispenser for dispensing lubricating fluid to the cutting tool, a pump for drawing fluid from the reservoir and pumping the fluid to the dispenser, and a control responsive to each power of the machine tool to direct the pump to pump a pre-selected quantity of lubricating fluid to the dispenser. The dispenser is connected to the pump by a conduit, and a check valve is provided at the dispenser for preventing lubricating fluid within the conduits from flowing back to the pump.

According to still another aspect of the invention, a system is provided for dispensing individual shots of a lubricating fluid used in drilling operations performed with a pneumatically powered, portable drill. The system includes a reservoir for holding lubricating fluid, and a pneumatically driven pump for drawing each shot of the lubricating fluid from a reservoir and for pumping the shot to the drilling operation. The system further comprises a controller responsive to each startup of the drill for connecting a source of pressurized air with a pump, the pump being responsive to pressurized air to pump a shot to the dispenser. In the preferred embodiment, the controller includes a user operator operated startup trigger carried on the drill and a flow control valve actuated by the trigger. Actuation of the startup trigger by the user in turn actuates the flow control valve, connecting the pressurized air source to both the drill and the pump. The pump includes a user adjustable pump stroke allowing pre-selection of the quantity of fluid in each shot.

Various additional objects, features and advantages of the present invention can be more fully appreciated with reference to the detailed description and accompanying drawings that follow.

### BRIEF DESCRIPTION OF THE DRAWINGS

FIG. 1 is block diagram of a portable tool lubrication system forming the preferred embodiment of the present invention.

FIG. 2 is a top view of the portable tool lubrication system, the cover of the enclosure having been removed to reveal components within interior of the enclosure.

FIG. 3 is bottom view of the system shown in FIG. 2.

FIG. 4 is a side elevation view showing details of the piston and cylinder assembly which forms the pump.

### DETAILED DESCRIPTION OF THE PREFERRED EMBODIMENTS

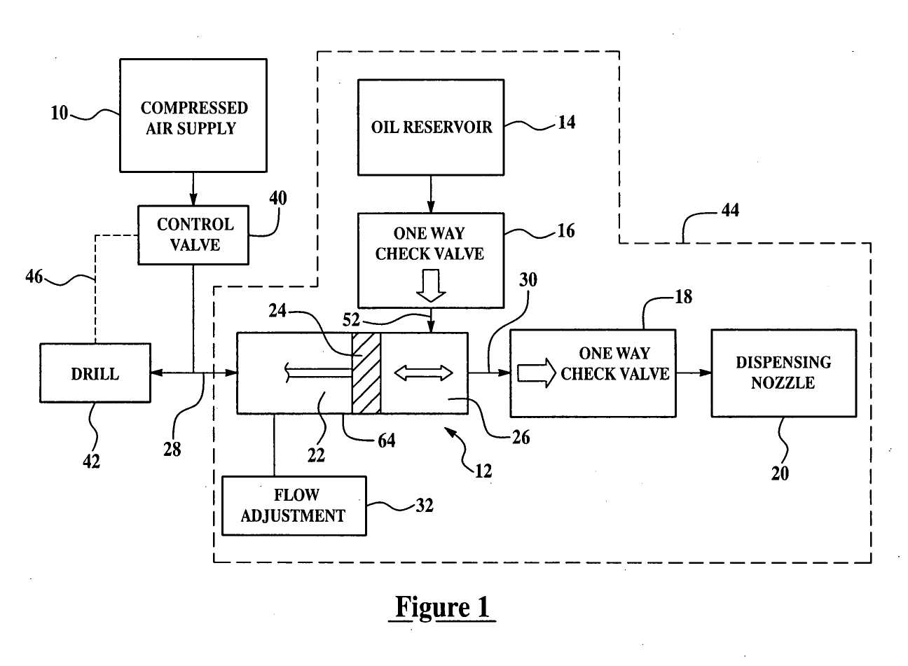

Referring first to FIG. 1, a portable lubrication system generally indicated within the broken line 44 is intended to be used with a portable machine tool, such as a drill 42. As will be later discussed, the portable lubrication system 44 may be mounted directly on the drill, or on fixtures upon which the drill is mounted to facilitate alignment and/or automation of the drilling operation. In any event, the lubrication system 44 is intended to be carried on or with the drill 42, and thus is fully portable. Portable machine tools such as the drill 42 are typically powered by compressed air. Accordingly, there is a compressed air supply 10 which is connected through a control valve 40 to drill 42. Typically, the control valve 40 will be mounted on, or may form an integral part of the drill 42. In any event, the valve 40 is controlled by a trigger or other mechanical switch on the drill 42 which the user actuates in order to start up the drill 42. When the drill trigger is depressed, a mechanical connection indicated at 46 to the valve 40 results in the valve 40 opening, thereby providing compressed air to the drill 42 which drives the latter.

The portable lubrication system 44 broadly comprises a pump 12, oil reservoir 14, dispensing nozzle 20 and a pair of check valves 16, 18. The pump 12 preferably comprises a piston and cylinder assembly including a cylinder 64 having a two-way piston 24 disposed therein which divides the cylinder into two chambers 22, 26. The pump 12 may be powered by a variety of power sources, but in the illustrated embodiment, it is powered by compressed air derived from the air supply 10. More particularly, chamber 22 in the cylinder 64 is coupled by line 28 to the control valve 40. Thus, it can be appreciated that when the drill 42 is initially turned on, control valve 40 allows compressed air to flow simultaneously to the drill and the pump 12.

The oil reservoir 14 stores a quantity of suitable cutting oil or lubricating oil which is periodically replenished by the user. Reservoir 14 is connected by a hydraulic line 52 to a one way check valve 16 which controls the flow of oil between reservoir 14 and cylinder chamber 26. During a retraction stroke of piston 24, a partial vacuum is drawn in chamber 26, thus opening check valve 16 and drawing oil from the reservoir 14 into the chamber 26, filling the latter with a precisely metered quantity of oil, which is a function of the stroke of the piston 24. A later discussed flow adjustment 32 is provided for the pump 12 which allows the user to adjust the exact quantity of oil drawn from the reservoir 14 into the chambers 26. The flow adjustment 32 may comprise any of a variety of well known devices which adjust the back or draw stroke of the piston 24.

As compressed air is delivered through line 28 into chamber 22, the piston 24 moves forwardly in a pumping stroke, forcing fluid in the chamber 26 to flow through check valve 18, then to a dispensing nozzle 20 which is typically located near the site on the workpiece or part where the hole is to be drilled. The nozzle 20 dispense the pre-measured “shot” of oil onto the drill bit or onto the workpiece, depending on the user's preference.

With a shot of oil having been dispensed, when the drilling operation is complete and the user releases the drill trigger, compressed air is removed from chamber 22 and a spring or other biasing mechanism (not shown) within the pump 12 causes the piston to move through its return stroke, toward the left as seen in FIG. 1. During the return stroke, any oil present within hydraulic line 30 is prevented from being drawn into the chamber 26 due to the presence of check valve 18. However, check valve 16 opens during the retraction stroke, allowing oil from the reservoir 14 to flow into the cylinder chamber 26, thus readying pump 12 to deliver the next shot of oil to nozzle 20 when the operator restarts the drill 42.

It can be seen from the arrangement shown in FIG. 1 that precisely controlled, pre-selected quantities of oil are delivered to the cutting operation each time the operator starts the drill 42. These shots of lubricating oil are delivered to the cutting operation automatically, without the need for the operator to manually perform any lubricating operations.

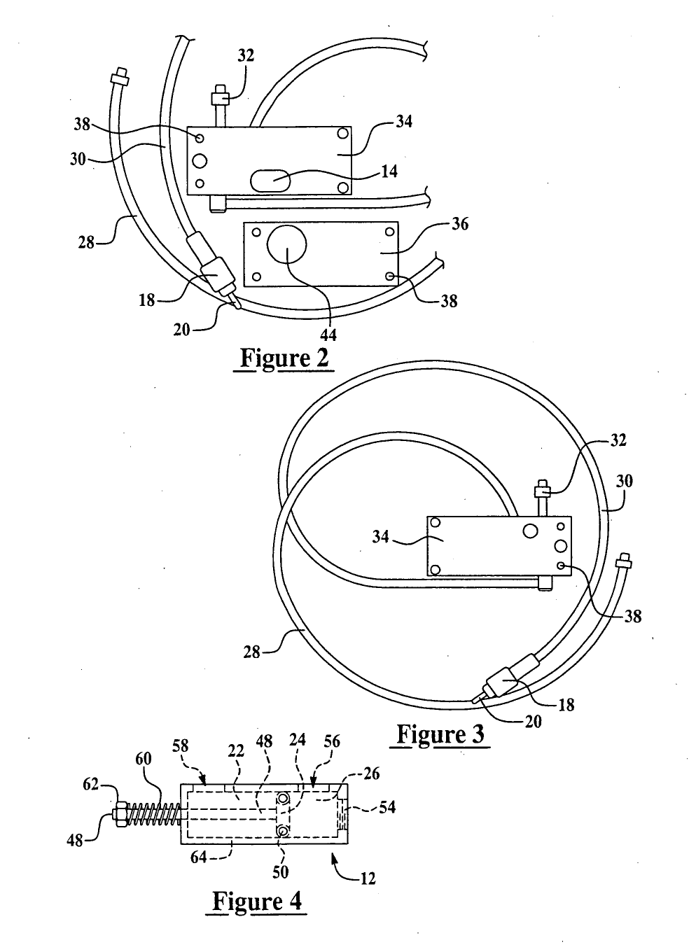

The portable lubrication system 44 can be implemented in a variety of physical embodiments, one of which is shown in FIGS. 2 and 3. A generally rectangular housing 34 contains a chamber defining the reservoir 14. The pump 12 as well as the check valve 16 along with related, connecting fluid passageways are formed within the housing 34 which may comprise, for example solid metal in which the passageways and components are formed and mounted. The housing 34 is provided with a cover 36 which is secured to one face of the housing 34 by means of screws (not shown) passing through screw holes 38. A removable screw 44 and cover 36 allow user access to the reservoir 14, permitting the user to refill the reservoir 14 when necessary. Flow adjustment 32 comprises a screw nut in the illustrated example, which adjusts the stroke of piston 24. The pump 12 contained in housing 34 is connected to the control valve 40 by means of a pneumatic line 28. The dispensing nozzle 20 forms part of an assembly including the check valve 18 and is connected to the housing 34 by means of a lubricating oil delivery line 30.

As previously indicated, the particular portable lubrication system 44 shown in FIGS. 2 and 3 can be mounted on or near the drill 42 so as to be carried along with the latter as the operator moves to different locations. The delivery line 30 is preferably made of flexible material allowing the nozzle 20 to be moved around the workpiece, as necessary. It should be noted here that delivery line 30 remains filled with fluid at all times, since even when piston 24 retracts to draw oil from reservoir 14, oil within delivery line 30 cannot be drawn back into the cylinder chamber 26 due to check valve 18 moving to its closed position.

The lubricating system 44 prevents the operator from applying too little or too much oil in any given drilling operation since only a single shot is delivered when the operator starts up the drill 42. Moreover, since the piston 24 automatically retracts to refill chamber 26 with oil when the operator turns off the drill 42, the operator need not remember to recharge or take any other action for preparing the lubrication system 44 for the next drilling operation.

The details of one suitable pump 12 are shown in FIG. 4. The cylinder 64 comprises a body having chambers 22 and 26 formed therein, as well as an air inlet port 58, an oil inlet port 56 and an oil outlet port 54. The air inlet port 58 is connected to pneumatic line 28, while oil inlet port 58 is connected to check valve 16 via line 52, and oil outlet port 54 is connected to check valve 18 by line 30. An 0-ring or similar seal 50 forms a fluid tight seal between the piston head 24 and the interior walls of the cylinder 64. A central shaft 48 connected to the piston 24 extends through one end of the cylinder 64 and has an outer threaded end provided with an adjustment nut 62. A compression spring 60 is captured between the body of the cylinder 64 and the nut 62, thus biasing the piston 24 to retract (toward the left as viewed in FIG. 4) The longitudinal position of the spring 60 on shaft 48 is therefore adjustable by nut 62. The position of spring 60 along the shaft 48 determines the length of the retraction stroke of piston 24, which in turn determines the volume of oil that is drawn into the chamber 26 from the reservoir 14.

The pressure of the compressed air entering air chamber 22 which is exerted on the piston 24 is always greater than the return force of the spring 60, thus permitting the compressed air to overcome the spring force when the drill 42 is switched on, and drive the piston 24 forward to deliver a shot of oil out through port 54. When the drill 42 is switched off, the air pressure in chamber 22 falls to a level below the force exerted by the spring 60, resulting in the spring 60 forcing the piston 24 to move through a return stroke. During this return stroke, oil is drawn into the chamber 26 through the inlet port 56, thus readying the system 44 for the next drill cycle.

Although this invention has been described with respect to certain exemplary embodiments, it is to be understood that the specific embodiments are for purposes of illustration and not limitation, as other variations will occur to those of skill in the art.

What is claimed is:

1. A lubrication system for a portable machine tool, comprising:
a reservoir for holding lubricating fluid;
a nozzle for dispensing a preselected quantity of the lubricating fluid:
a pump assembly for drawing the preselected quantity of the lubricating fluid from the reservoir, and for pumping the preselected quantity of the lubricating fluid to the nozzle; and,
a pump control responsive to operation of the machine tool for causing the pump to pump the preselected quantity of lubricating fluid to the nozzle.

2. The lubrication system of claim 1, wherein the pump includes a cylinder for receiving the preselected quantity of the lubricating fluid drawn from the reservoir, and a piston within the cylinder, the piston being driven by compressed air to force the preselected quantity of the lubricating fluid from the cylinder to the nozzle.

3. The lubrication system of claim 2, wherein the pump control includes a valve coupled between a source of compressed air and the combination of the machine tool and the pump, the valve being switchable to an open upon start up of the machine tool to allow compressed air to be delivered to the machine tool and the pump.

4. The lubrication system of claim 3, further comprising a first check valve for preventing lubricating fluid in the cylinder from flowing back to the reservoir, and a second reservoir for preventing lubricating fluid from flowing from the nozzle back to the cylinder.

5. The lubrication system of claim 1, wherein the pump includes an adjustment for adjusting the amount of the preselected quantity of the lubricating fluid drawn from the reservoir.

6. The lubrication system of claim 1, further comprising a check valve for preventing the preselected quantity of lubricating fluid drawn from the reservoir from flowing from the pump back to the reservoir.

7. The lubrication system of claim 1, further comprising a check valve for preventing lubricating fluid from flowing from the nozzle back to the pump.

8. A cutting tool lubrication system carried on a portable machine tool, comprising:
a reservoir for holding lubricating fluid;
a dispenser for dispensing lubricating fluid to the cutting tool:
a pump for drawing a preselected quantity of the lubricating fluid from the reservoir, and for pumping the preselected quantity of the lubricating fluid to the dispenser; and,
a control responsive to each power-up of the machine tool to direct the pump to pump a preselected quantity of lubricating fluid to the dispenser.

9. The lubrication system of claim 8, wherein:
the pump and the machine tool are each driven by compressed air,
the control includes a valve operated by start-up of the machine tool to place a source of compressed air in air flow communication with the machine tool and the pump, the pump being responsive to receiving compressed air to pump the preselected quantity of the lubricating fluid to the dispenser.

10. The lubrication system of claim 8, further comprising a conduit for conveying lubricating fluid from the pump to the dispenser, and a one way valve for allowing flow of lubricating fluid through the conduit to the dispenser, but from preventing return flow of the fluid from the conduit back to the pump.

11. The lubrication system of claim 8, further comprising a one way valve for allowing flow of the lubricating fluid from the reservoir to the pump, but from preventing return flow of the fluid from the pump to the reservoir.

12. The lubrication system of claim 8, wherein the pump includes a cylinder for holding the preselected quantity of the lubricating fluid, and a piston for pumping the fluid in the cylinder to the dispenser.

13. The lubrication system of claim 12, wherein the pump includes an adjustment for adjusting the stroke of the piston to thereby change the amount of the preselected quantity of fluid pumped to the dispenser.

14. The lubrication system of claim 12, wherein the piston is alternately driven between a forward stroke in which fluid in the cylinder is pumped to the dispenser, and in a return stroke in which fluid is drawn from the reservoir to the cylinder.

15. For use with a pneumatically powered, portable drill, a system carried with the drill for dispensing individual shots of a lubricating fluid used in drilling operations, comprising:
a reservoir for holding lubricating fluid; and,
a pneumatically driven pump for drawing each shot of the lubricating fluid from the reservoir, and for pumping the drawn shot to a drilling operation.

16. The lubrication system of claim 15, further comprising a controller responsive to each start-up of the drill for connecting a source of pressurized air with the pump, the pump being responsive to receipt of pressurized air to pump a drawn shot to the dispenser.

17. The lubrication system of claim 16, wherein the controller includes a user operated start up trigger carried on the drill, and a flow control valve actuated by the trigger, actuation of the flow control valve connecting the pressurized air source to the drill and to the pump.

18. The lubrication system of claim 15, wherein the pump has a user adjustable pump stroke allowing preselection of the quantity of the fluid in each shot.

19. The lubrication system of claim 15, further comprising a dispenser for dispensing the individual shots at the site of the drilling operation, and a conduit for delivering each of the shots from the pump to the dispenser.

20. The lubrication system of claim 19, further comprising a first flow control valve for preventing a shot drawn by the pump from flowing back to the reservoir, and a second flow control valve for preventing lubricating fluid in the conduit from flowing back to the pump.
